(19) United States
(12) Patent Application Publication
(10) Pub. No.: US 2007/0233398 A1
(43) Pub. Date: Oct. 4, 2007

(54) Oligonucleotide microarray probe design via statistical regression analysis of experimental data

(76) Inventors: Svetlana V. Shchegrova, Campbell, CA (US); Peter G. Webb, Menlo Park, CA (US); Douglas N. Roberts, Campbell, CA (US); B. Shane Giles, Fremont, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/390,797

(22) Filed: Mar. 28, 2006

(51) Int. Cl. G06F 19/00

(52) U.S. Cl. 702/20

(57) ABSTRACT

Methods are disclosed for predicting the performance of oligonucleotide probes by identifying the sequence of a candidate probe, generating experimental data for the probe and using the data to train a statistical regression model. Nucleic acid arrays containing probes with performance predicted by the described using methods are provided. Also included are algorithms for performing the subject methods recorded on computer-readable media, and computational systems for analysis.

### BACKGROUND

Microarray technology is now commonly used as a tool for high throughput genomic analysis, analysis of genotype, and gene expression analysis. Genomic microarray applications include array-based comparative genomic hybridization (aCGH), a technique used to determine the amounts of a given species of nucleic acid in a sample relative to a reference sample. In aCGH, genomic DNA is purified away from cellular components of reference and test cells to determine differences in genomic copy number. The purified genomic DNA from reference and test cells is differentially labeled and then hybridized competitively to a microarray containing probes representing the genome.

Oligonucleotides, or probes, used in genomic applications such as aCGH often target different regions of the genome, and can show significant differences in hybridization efficiency. Probes for aCGH applications are selected empirically based on the structure of the genome, the structure of the probe, and model systems containing samples with known genetic variations. Probe design is optimized so as to increase hybridization efficiency, while reducing the number of empirical observations or iterations necessary.

Currently, probes for aCGH are selected by filtering candidate probes based on in-silico computed parameters, and using basic trial and error methods. Filtering is done by applying hard cut-off parameters and scoring the probes that pass the filter according to individual parameter values. However, the parameters do not always equally contribute to probe performance, cut-off values are chosen arbitrarily to a large extent, and in many cases, there are no good model systems to empirically validate probes.

### SUMMARY

This patent is directed to methods for predicting probe performance for microarray applications. The methods described herein use statistical modeling to predict the performance of oligonucleotide probes. In an aspect, the methods described herein include identifying a candidate oligonucleotide for a particular biological model system. Data obtained from the candidate probes is used to create a statistical model for predicting the performance of probes for other biological systems.

The methods described herein use statistical methods to evaluate the performance of probes for a chromosome in a genome. In an aspect, representative data is obtained from a tiling array and then analyzed. The analysis includes identification of response variables and predictors, and performing regression analysis to determine the functional dependence of observed signals on probe parameters.

Algorithms for performing the described methods recorded on a computer-readable medium, as well as computational analysis systems that include the same are provided. Also provided are nucleic acid arrays with oligonucleotide probes whose performance is predicted using the subject methods, and methods for using such arrays.

### BRIEF DESCRIPTION OF THE DRAWINGS

FIG. 1 is a flowchart generally depicting the methods described herein.

FIG. 2 is a flowchart showing the probe design, according to the methods disclosed herein.

FIG. 3 is a flowchart of the experimental validation of the probes, according to the methods described herein.

FIG. 4 shows a distribution of measured LogRatio in the training data for a CGH experiment.

FIG. 5 depicts a schematic diagram of the filtration process used during probe design as disclosed herein.

FIG. 6 shows a graphical representation of the experimental validation of the probes, as applied in the methods described herein.

FIG. 7 is a schematic diagram of a regression tree model as applied in the methods described herein.

### DETAILED DESCRIPTION

Various embodiments of the methods described herein will be described in detail with reference to the drawings, wherein like reference numerals represent like parts throughout the several views. Reference to various embodiments does not limit the scope of the claims attached hereto. Additionally, any examples set forth in this specification are not intended to be limiting and merely set forth some of the many possible embodiments for the claims.

Unless defined otherwise, all technical and scientific terms used herein have the same meaning as commonly understood to one of ordinary skill in the art. Although any methods, devices and material similar or equivalent to those described herein can be used in practice or testing, the methods, devices and materials are now described.

The term “genome” refers to all nucleic acid sequences (coding and non-coding) and elements present in or originating from a single cell or each cell type in an organism. The term genome also applies to any naturally occurring or induced variation of these sequences that may be present in a mutant or disease variant of any virus or cell type. These sequences include, but are not limited to, those involved in the maintenance, replication, segregation, and higher order structures (e.g. folding and compaction of DNA in chromatin and chromosomes), or other functions, if any, of the nucleic acids as well as all the coding regions and their corresponding regulatory elements needed to produce and maintain each particle, cell or cell type in a given organism. For example, eukaryotic genomes in their native state have regions of chromosomes protected from nuclease action by higher order DNA folding, protein binding, or subnuclear localization.

For example, the human genome consists of approximately 3×10⁹ base pairs of DNA organized into distinct chromosomes. The genome of a normal diploid somatic human cell consists of 22 pairs of autosomes (chromosomes 1 to 22) and either chromosomes X and Y (males) or a pair of X chromosomes (female) for a total of 46 chromosomes. A genome of a cancer cell may contain variable numbers of each chromosome in addition to deletions, rearrangements and amplification of any subchromosomal region or DNA sequence.

The term “nucleic acid” as used herein means a polymer composed of nucleotides, e.g., deoxyribonucleotides or ribonucleotides, or compounds produced synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions.

The terms “ribonucleic acid” and “RNA” as used herein mean a polymer composed of ribonucleotides.

The terms “deoxyribonucleic acid” and “DNA” as used herein mean a polymer composed of deoxyribonucleotides.

The term “oligonucleotide” or “polynucleotide” as used herein refers to a nucleotide multimer, i.e. a polymer composed of either DNA or RNA, and used as probes to find a complementary sequence of DNA or RNA. Like DNA, oligonucleotides comprise sequences of the bases A, T, G and C, and the composition of the oligonucleotide can be expressed as a mole fraction or percentage of one or more bases. The nucleotide multimer may have any number of nucleotides.

An “oligonucleotide probe” refers to a moiety made of an oligonucleotide or polynucleotide, containing a nucleic acid sequence complementary to a nucleic acid sequence present in a portion of a polynucleotide such as another oligonucleotide, or a target nucleic acid sequence, such that the probe will specifically hybridize to the target nucleic acid sequence under appropriate conditions.

The term “sample” or “experimental sample” as used herein relates to a material or mixture of materials, typically, although not necessarily, in fluid form, containing one or more components of interest. Samples include, but are not limited to, biological samples obtained from natural biological sources, such as cells or tissues. The samples also may be derived from tissue biopsies and other clinical procedures.

A “biological model system,” as provided herein, refers a system for which a quantitative response in a microarray experiment can be expected with certainty. Exemplary model systems include, without limitation, titration series with several RNA samples at different concentrations, sample with a known genomic aberrations, etc. The biological model systems are used to perform microarray experiments and obtain a set of training data for statistical analysis. The term “biological system” or “other biological system” refers to a system other than the system used to obtain the training data.

The term “array” encompasses the term “microarray” and refers to an ordered array presented for binding to nucleic acids and the like. Arrays, as described in greater detail below, are generally made up of a plurality of distinct or different features. The term “feature” is used interchangeably herein with the terms: “features,” “feature elements,” “spots,” “addressable regions,” “regions of different moieties,” “surface or substrate immobilized elements” and “array elements,” where each feature is made up of oligonucleotides bound to a surface of a solid support, also referred to as substrate immobilized nucleic acids.

An “array,” includes any one-dimensional, two-dimensional or substantially two-dimensional (as well as a three-dimensional) arrangement of addressable regions bearing a particular chemical moiety or moieties (such as ligands, e.g., biopolymers such as polynucleotide or oligonucleotide sequences (nucleic acids), polypeptides (e.g., proteins), carbohydrates, lipids, etc.) associated with that region. In the broadest sense, the arrays of many embodiments are arrays of polymeric binding agents, where the polymeric binding agents may be any of: polypeptides, proteins, nucleic acids, polysaccharides, synthetic mimetics of such biopolymeric binding agents, etc. In many embodiments of interest, the arrays are arrays of nucleic acids, including oligonucleotides, polynucleotides, cDNAs, mRNAs, synthetic mimetics thereof, and the like. Where the arrays are arrays of nucleic acids, the nucleic acids may be covalently attached to the arrays at any point along the nucleic acid chain, but are generally attached at one of their termini (e.g. the 3′ or 5′ terminus). Sometimes the arrays are arrays of polypeptides, e.g., proteins or fragments thereof.

In those embodiments where an array includes two more features immobilized on the same surface of a solid support, the array may be referred to as addressable. An array is “addressable” when it has multiple regions of different moieties (e.g., different polynucleotide sequences) such that a region (i.e., a “feature” or “spot” of the array) at a particular predetermined location (i.e., an “address”) on the array will detect a particular target or class of targets (although a feature may incidentally detect non-targets of that feature). Array features are typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “probe” may be the one that is to be evaluated by the other (thus, either one could be an unknown mixture of analytes, e.g., polynucleotides, to be evaluated by binding with the other).

A “scan region” refers to a contiguous (preferably, rectangular) area in which the array spots or features of interest, as defined above, are found. The scan region is that portion of the total area illuminated from which the resulting fluorescence is detected and recorded. For the purposes of this invention, the scan region includes the entire area of the slide scanned in each pass of the lens, between the first feature of interest, and the last feature of interest, even if there are intervening areas that lack features of interest.

An “array layout” refers to one or more characteristics of the features, such as feature positioning on the substrate, one or more feature dimensions, and an indication of a moiety at a given location. “Hybridizing” and “binding”, with respect to polynucleotides, are used interchangeably.

The term “substrate” as used herein refers to a surface upon which marker molecules or probes, e.g., an array, may be adhered. Glass slides are the most common substrate for biochips, although fused silica, silicon, plastic, flexible web and other materials are also suitable.

The terms “hybridizing specifically to” and “specific hybridization” and “selectively hybridize to,” as used herein refer to the binding, duplexing, or hybridizing of a nucleic acid molecule preferentially to a particular nucleotide sequence under stringent conditions.

The term “stringent assay conditions” as used herein refers to conditions that are compatible to produce binding pairs of nucleic acids, e.g., surface bound and solution phase nucleic acids, of sufficient complementarity to provide for the desired level of specificity in the assay while being less compatible to the formation of binding pairs between binding members of insufficient complementarity to provide for the desired specificity. Stringent assay conditions are the summation or combination (totality) of both hybridization and wash conditions.

A stringent hybridization and stringent hybridization wash conditions in the context of nucleic acid hybridization (e.g., as in array, Southern or Northern hybridizations) are sequence dependent, and are different under different experimental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO₄, 7% sodium dodecyl sulfate (SDS), 1 mM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions that set forth the conditions that determine whether a nucleic acid is specifically hybridized to a surface bound nucleic acid. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C.

A specific example of stringent assay conditions is rotating hybridization at 65° C. in a salt based hybridization buffer with a total monovalent cation concentration of 1.5 M (e.g., as described in U.S. patent application Ser. No. 09/655,482 filed on Sep. 5, 2000, the disclosure of which is herein incorporated by reference) followed by washes of 0.5×SSC and 0.1×SSC at room temperature.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions are known in the art and may also be employed, as appropriate.

In this specification and the appended claims, the singular forms “a,” “an,” and “the” include plural reference, unless the context clearly dictates otherwise. Unless defined otherwise, all technical and scientific terms used herein have the same meaning as commonly understood to one of ordinary skill in the art.

Approach and Methods for Predicting Probe Performance

Methods or algorithms for designing microarray probes, and methods or algorithms for predicting probe performance are described. An initial probe is designed using a model system, and experimental data is generated for the probe.

This data is then used to statistically model other probes that target other, specific parts of the genome. More specifically, the experimental data is used to train a statistical regression model, and the model can then be used to predict the performance of probes in other experiments.

The approach to building a robust probe evaluation system consists of several steps. Initially, a set of parameters that adequately describe an oligonucleotide is generated. A biological model system for which a quantitative response in a microarray experiment can be expected with certainty is then identified. For example, a titration series with several RNA samples at different concentrations, or a sample with a known genomic aberration, can be used. Microarray experiments are then performed using the model system. The experimental data is compared to the expected response using regression analysis. The analysis establishes the functional dependence of the probe performance on probe parameters used in the experiment. This functional dependence is used in future applications to predict the probe performance when the actual “correct” response is not known (i.e. a biological model system cannot be easily constructed).

A method for evaluating the performance of an oligonucleotide probe is provided herein. Probe performance or probe evaluation is based on any or all of a set of measured quantities. In an aspect, these measured quantities are from a pair of dye-swap experiments. The measured quantities include LogRatio (the log of the ratio of red to green channels), LogIntensity (the log product of red and green channel intensities), and dye bias (the average of log ratios for a dye-swap pair), for example. These quantities are defined by the following equation (Equation I):

$$LogRatio = log ( {I}_{red} / {I}_{green} ) \\ {I}_{total} = \sqrt{{I}_{red} * {I}_{green}} \\ DyeBias = ( {LogRatio}_{polarity 1} + {LogRatio}_{polarity - 1} ) \qquad ( I )$$

where I denotes a measured signal intensity in either the red or green channel, and polarity (−1 or +1) refers to a pair of dye-swap experiments, where the same pair of samples is alternately labeled with red and green dyes.

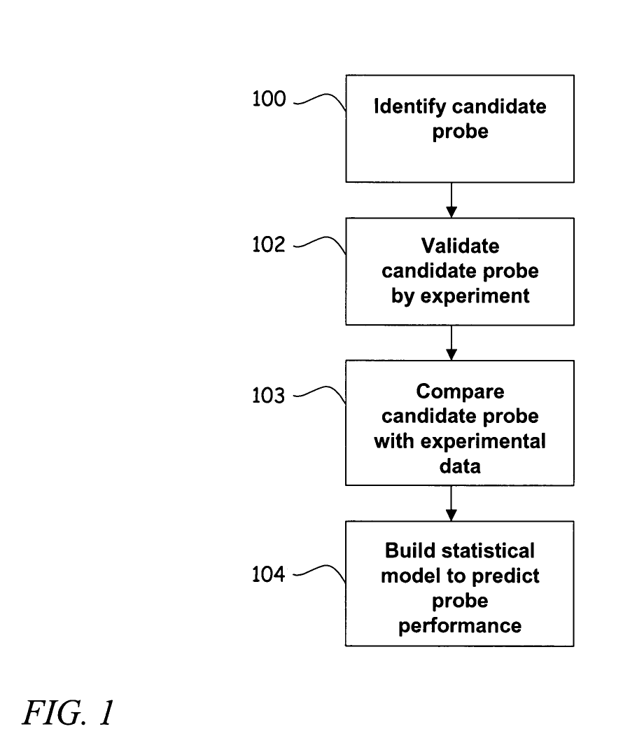

FIG. 1 shows a general description of the method described herein. In an aspect, as in operation 100, a candidate oligonucleotide probe for a particular region of a genome, or a particular region of a target nucleic acid sequence, is identified or designed. The term “design” or “probe design” means identifying a candidate oligonucleotide probe sequence that accurately represents a selected region of the genome, or a selected region of a given target nucleic acid of interest. The designed probe is then validated. Validation refers to the selection of specific probes, which are then hybridized to different experimental samples on a microarray 102, followed by comparison of the behavior of the designed probe with the expected behavior under known conditions, as in 103. Data from the comparison can be used to build a statistical model, as indicated in 104. Statistical models include tree models, such as the classification model or regression tree model, for example. The model can be used to predict probe performance for parts of the genome other than the region for which the probe was originally designed.

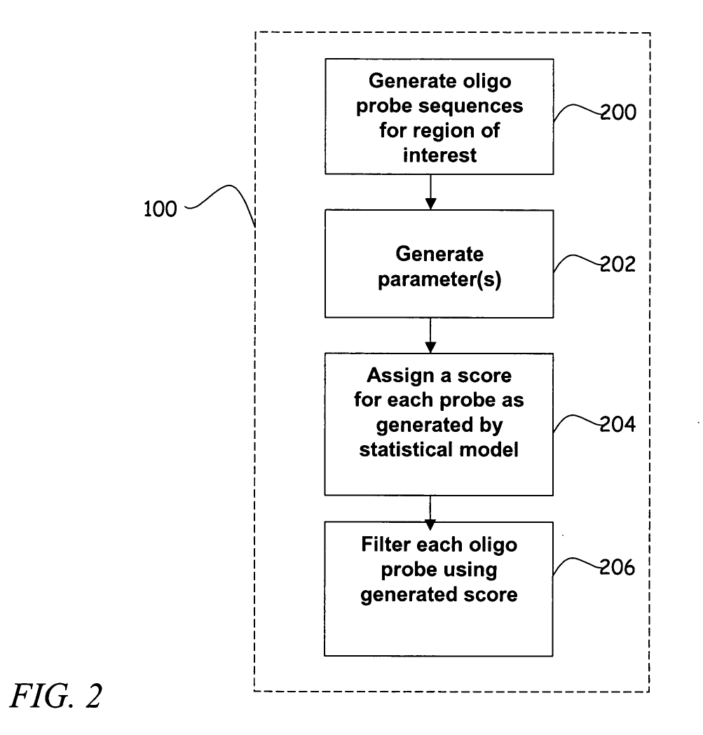

In an embodiment, a candidate oligonucleotide probe for a particular region of a genome is designed as in operation 100, an expanded representation of which is shown in FIG. 2. Briefly, operation 100 begins with synthesis or generation 200 of oligonucleotides that accurately represent a region of the genome sequence, or a region of a target nucleic acid sequence, as far as parameter space is concerned. The set of generated or identified oligonucleotides comprises a set of training data. This is followed by the determination of predictive parameters in step 202. The predictive parameters include, without limitation, composition factors, thermodynamic factors, kinetic factors, and mathematical combinations of such factors, as well as analogous parameters for the intended genomic targets. These parameters are used to assign a score value to the probes in step 204. The score value is based on any one of the measured quantities used to predict probe performance, or a combination of measured quantities. The measured quantities include LogRatio (the log of the ratio of red to green channels), LogIntensity (the log product of red and green channel intensities), and dye bias (the average of log ratios for a dye-swap pair). For example, a geometrical mean of LogRatio and LogIntensity can be used. The score values are assigned by comparing the measured quantities to the expected behavior of the probe (i.e. the expected response for the probe) under known conditions. The probes are then filtered based on the assigned score value to obtain a subset of probes with the best-predicted performance, as shown in step 206. The term “filtered” refers to the process by which probes that consistently produce the same response are grouped together (or clustered), and then separated from those probes that produce inconsistent responses (i.e. non-clustering probes). Clustered probes are more predictive of probe performance than probes that do not cluster.

In step 200, a number of unique oligonucleotides are identified, where the length of all the oligonucleotides is either the same or different, and two oligonucleotides may or may not be identical. The length of the oligonucleotide is chosen based on the entire length of a chosen region of the genome, or region of the target nucleic acid sequence being analyzed, such as the length of a chromosome, or the length of a sequence corresponding to an mRNA transcript of interest, for example. Usually, the length of the oligonucleotides is from about 25 to about 75 nucleotides.

The actual number of oligonucleotides in a training data set depends on the length of the nucleic acid sequence or the region of the genome being sampled, and the desired statistical accuracy. Therefore, enough oligonucleotides are generated in certain embodiments to ensure that several probes overlap or fall within the chosen target nucleic acid sequence or region of the genome. The training data set typically contains between about 10,000 and about 100,000 oligonucleotide probes, depending on the application for which probe performance is predicted. For example, for a typical CGH experiment, the training data set will contain between 30,000 and 100,000 oligonucleotide probes per microarray, depending on the length of the chromosome being used as the target sequence. A method for determining the actual number of oligonucleotides is described in U.S. Pat. No. 6,251,588, which is incorporated herein by reference.

Because the location of the desired region in the target sequence or genome may be unknown, one strategy is to equally space the oligonucleotide sequences along the genome sequence or target nucleic acid sequence. This can be accomplished by using a tiling array, i.e. a type of microarray where probes are not designed to target known genomic regiones, e.g., genes or portions thereof, such as coding sequences, promoters, etc. Rather, probes are simply laid down at regular intervals along the length of the genome. Tiling arrays include overlapping oligonucleotide that represent an entire genomic region of interest. The interval spacing (or resolution) can range from about 5 bp to as many as 500 bp, for a tiling array containing 10 chromosomes, for example. A tiling array, as used in embodiments of the methods described herein, uses 60-mer oligonucleotide sequences on the tiling array surface, wherein each 60-mer is a sequence beginning about 5 bp apart from the adjacent 60-mer.

The probe design process 100 next includes step 202 for generating or determining at least one parameter that is independently predictive of the ability of the oligonucleotide to act as a probe for the chosen region of the genome or target nucleic acid sequence (i.e. the ability of the probe to hybridize to a chosen region of the genome or target nucleic acid sequence). The parameters include, without limitation, composition factors, thermodynamic factors, kinetic factors, and mathematical combinations of such factors, as well as analogous parameters for the intended genomic targets. Methods for calculating such parameters are known to those of skill in the art, and closely parallel the parameters used to control the stringency of hybridization (i.e. parameters or conditions that are conducive to producing binding pairs of nucleic acids, for example).

Composition factors are numerical factors based on the composition or sequence of the oligonucleotide. Examples include, without limitation, mole fractions of the bases A, T, G and C, percentage of A, T, G, or C, mole fraction (G+C), percentage (G+C), sequence complexity, existence of repeat units, existence of restriction sites, etc.

Thermodynamic factors are numerical factors that predict the behavior of an oligonucleotide in some process at equilibrium, such as the free energy of duplex formation between an oligonucleotide probe and its complement. Examples include, but are not limited to, predicted duplex melting temperature, predicted enthalpy of duplex formation, predicted entropy of duplex formation, etc. The predicted duplex melting temperature is the temperature at which an oligonucleotide and 50% of a complementary sequence form a double-helix hybrid. Other thermodynamic parameters include, without limitation, predicted melting temperature of the most stable intramolecular structure of the oligonucleotide or its complement (i.e. self-complementary sequences formed as intramolecular secondary structures), predicted enthalpy of the most stable intramolecular structure, predicted free energy of the most stable intramolecular structure, predicted entropy of the most stable intramolecular structure, etc. Similar thermodynamic parameters for other structures, such as, for example, the most stable hairpin structure, are also used.

Kinetic factors are numerical factors that predict the rate at which an oligonucleotide probe hybridizes to a chosen region of the genome (i.e. to its complement). Examples include, but are not limited to, steric factors obtained from experimental or molecular modeling data, rate constants calculated from simulations, dissociative rate constants, associative rate constants, enthalpies of activation, entropies of activation, free energies of activation, etc.

Using Classification Models for Microarray Applications

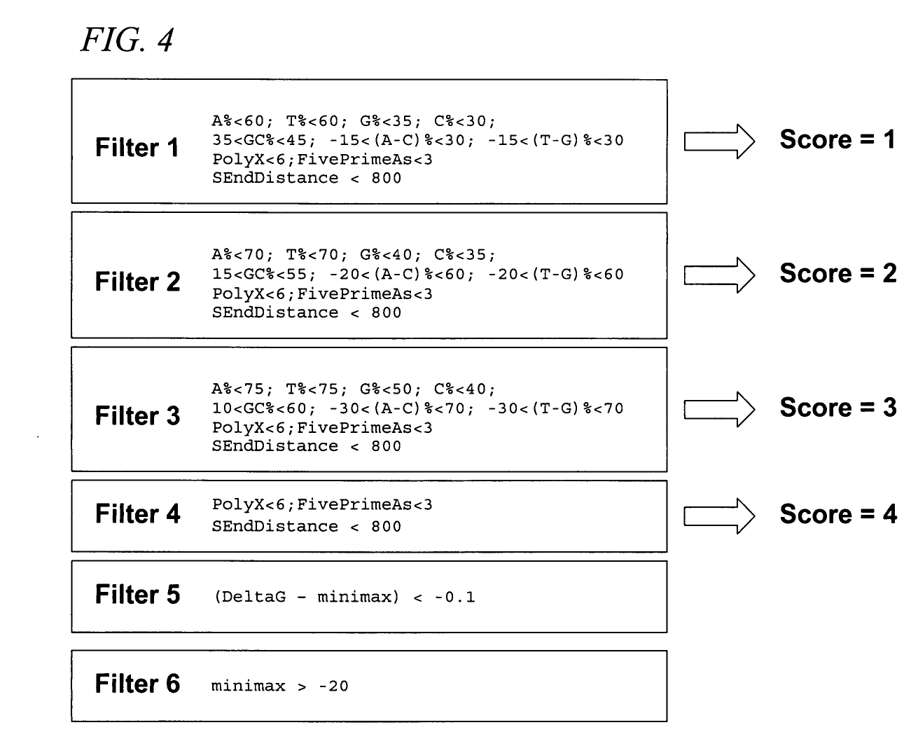

Aspects of the invention include methods for evaluating the performance of an oligonucleotide probe for use in various microarray applications, including gene expression applications and genomic microarray applications. In embodiments, parameters selected in step 202 are used in a filtering step 204, to obtain a subset of oligonucleotides that act as probes. A number of mathematical approaches, as computerized algorithms, can be used to filter the oligonucleotides based on the parameters described above. In an embodiment, a cut-off value can be used to filter the oligonucleotides. The cut-off value is adjustable and can be optimized relative to training data. Methods or algorithms for optimizing such cut-off values are known to those of skill in the art. In another embodiment, the cut-off value can be estimated from graphical methods. The cut-off values are chosen so as to maximize the inclusion of oligonucleotide probes for the chosen region of the genome being analyzed. The filtration algorithm uses multiple filters for the oligonucleotide probes, and then assigns dimensionless score values to each probe, as in step 206. In embodiments, filtering scores are assigned to the oligonucleotides on the basis of certain parameters. In an embodiment, the possible filter scores range from 1 to 4. FIG. 4 shows an embodiment of the filtering step, involving different filters, with each filter applying different cut-off values for the selected parameters. For example, as shown in FIG. 4, but not limited to any particular embodiment, Filter 1 assigns a score of 1 to probes that have composition parameters of A%<60; T%<60; G%<35; C%<30, etc. In other possible embodiments, the cut-off values for predictive parameters may be altered to values other than those shown in the figure. Filtering in this manner provides an objective method for optimizing the oligonucleotides. The probes are then ranked in terms of their filter scores, and the oligonucleotide probe subset obtained after the filtration is considered a probe set designed by the computerized algorithm or software.

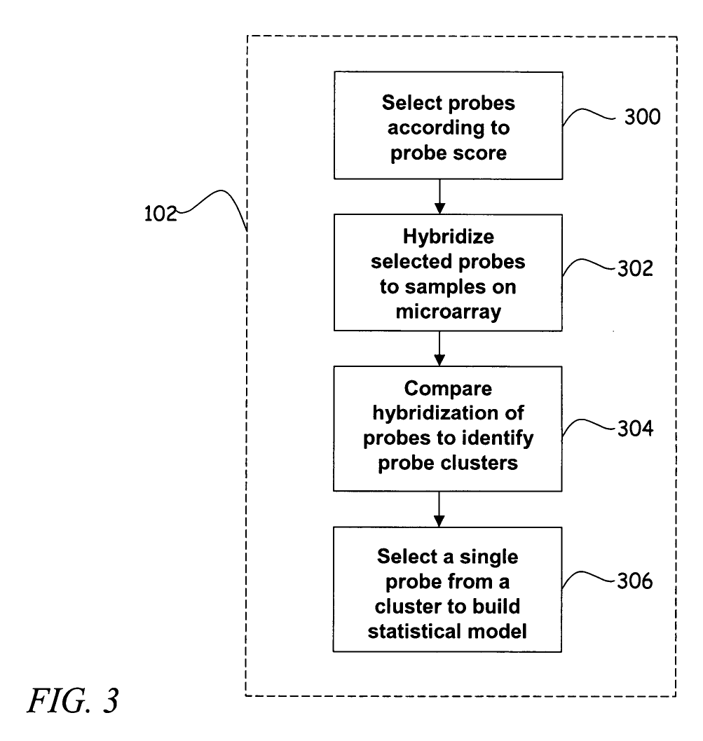

As shown in FIG. 1, embodiments of the methods for evaluating probe performance include a validation process 102. The subset of probes from the filtration process is experimentally validated. Process 102 is further depicted in FIG. 3. Briefly, in step 300, oligonucleotide probes are selected according to their probe scores from the filtering step 204 and scoring step 206. Selected probes are then hybridized to different samples in microarray experiments 302. In step 304, the hybridization results for several probes designed for the same part of the genome are compared in step 306 to identify a single probe that can be used to build a statistical model.

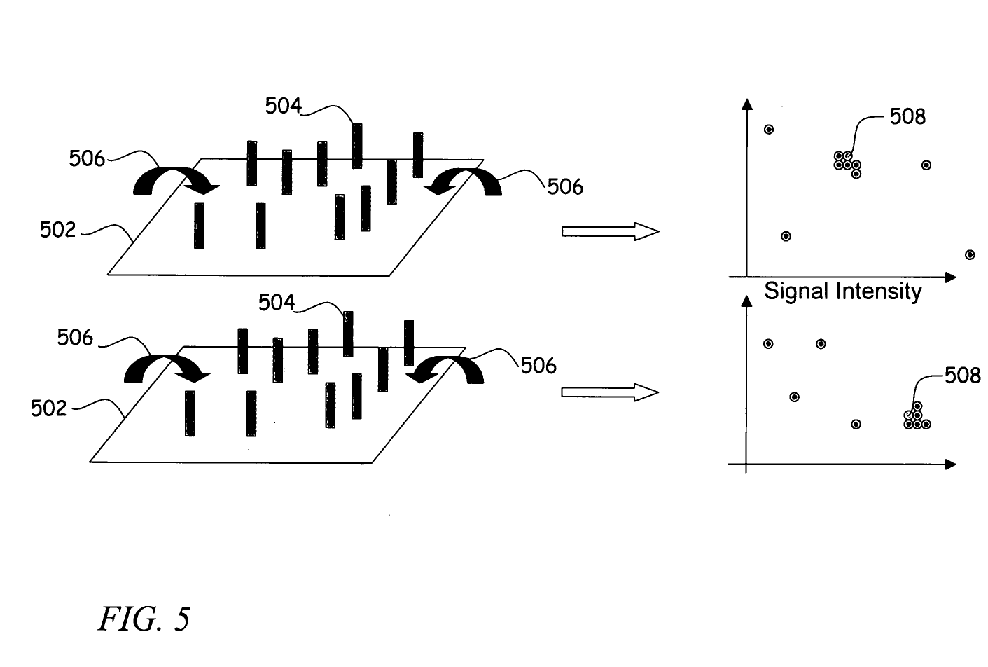

A graphical representation of the hybridization step 304 is provided in FIG. 5. In an embodiment, several designed probes 504 per gene (or chosen region of the genome) are selected and spotted onto a microarray or tiling array 502. In an aspect, the microarray includes 10 or more probes per gene or chromosome, where the 10 or more probes may be complementary to different domains of the gene or chromosome of interest. The selected oligonucleotides are then hybridized to nucleic acids isolated from different samples 506. The samples may include, without limitation, samples obtained from tissues, such as liver, brain, spleen, etc., for example. The signal intensities measured from the microarray are plotted against LogRatio. Oligonucleotides that consistently produce the same response appear as clusters 508, or tightly grouped data points on the plot. These probes are designated “clustering” probes, and are identified as desirable for use in future microarray experiments. In embodiments, a classification model is built, where the “clustering” versus “non-clustering” behavior of a probe is identified as a response variable. A similar method of experimental validation is described in U.S. Patent Publication No. 20050282174, the contents of which are incorporated herein by reference. The parameters described above are treated as predictors. Using a classification and regression tree (CART) model, as described in Hastie et al., The Elements of Statistical Learning, Springer (2001), the functional dependence of the response variables on the predictor parameters can be determined.

Using Statistical Regression Analysis for CGH Microarray Applications

The methods described herein are used to predict the performance of oligonucleotide probes in comparative genomic hybridization (CGH) microarray applications. In an embodiment, the method described herein is used in an experiment to evaluate the performance of oligonucleotide probes for chromosome X in a normal male-female sample pair. In an aspect, the probe is expected to produce a 2:1 signal ratio corresponding to a 2:1 ratio in genomic DNA concentration between two samples. The experiment involves tiling chromosome X with a microarray consisting of 60-mers. A representative subset of oligonucleotide probes is obtained, after filtration with the appropriate parameters. The data obtained from the tiling array is used to train a regression model. The multiple additive regression tree (MART) model is used to perform the regression analysis to establish the relationship between the probe parameters and the probe performance, without using any assumptions about the functional relationship. In another embodiment, the Neural Network model is used, with the advantage of having multiple response variables for the same training data. Using Neural Network, the trained model can then be used to predict probe performance for parts of the genome not belonging to chromosome X.

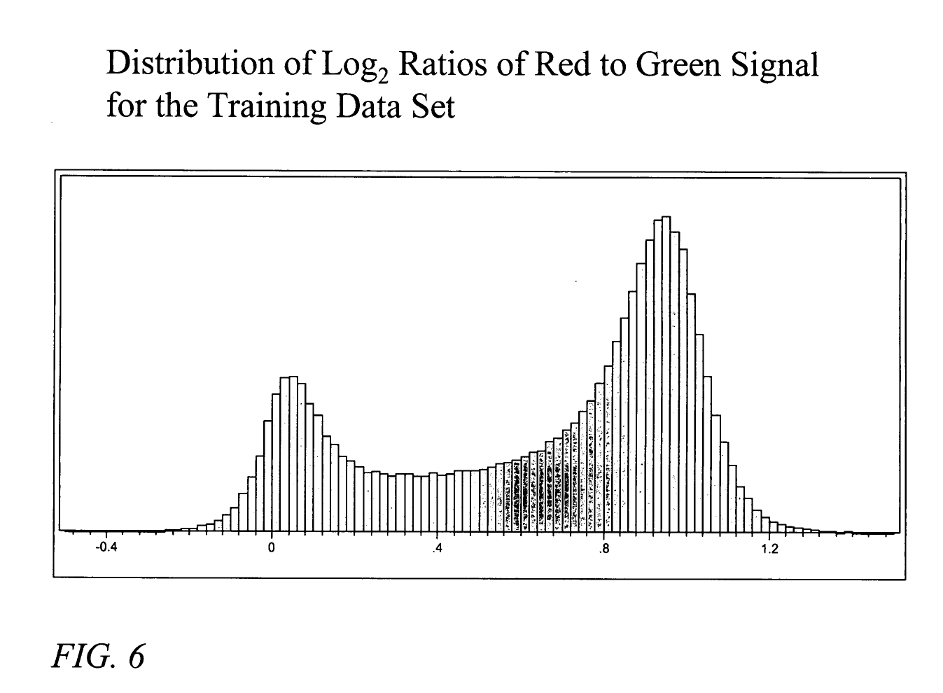

In embodiments of the methods provided herein, the experiment includes oligonucleotide probes tiling chromosome X. Several thousand probes can be tiled for the X chromosome on the microarray. In one aspect, 310,000 probes are tiled, spread over 8 probe designs. Two microarrays are used for each design, to perform a dye-swap experiment, giving a total of 16 microarrays. For each probe design, two experiments with normal male-female samples are used, with male and female samples labeled alternatively with green and red dyes. All probes, with the exception of saturated probes and statistical outliers are then included in the training of the data set. The set of oligonucleotides (i.e. training data or training set) is used to train a statistical regression model. The distribution of measured LogRatio for the data set is shown in FIG. 6. Whereas the expected “correct” LogRatio is 1, it can be deduced from FIG. 6 that a wide range of probe performance is represented in the data set, where the measured LogRatio varies approximately by −0.5 to 1.5. This can be mapped to the range of parameters via regression analysis.

The statistical model is created by first identifying the response variables and the predictors. In an aspect, an oligonucleotide probe's log of signal ratio, signal intensity, and the difference between log signal ratios for a pair of dye-swap experiments are used as the continuous response variables. Probe design parameters are used as predictors. In embodiments, the predictors are, without limitation, calculated duplex melting temperature, calculated melting temperature of the most stable intramolecular structure, complexity, number of repeat units and restriction sites, length of probe, etc. Other predictors such as free energy of duplex formation, percentage of (G+C), percentage of A, percentage of 5′-A, etc. can also be used to build the statistical model. Once the response variables and predictors have been selected, the total distribution of probes is then fitted to the model predictors (or parameters) using multiple additive regression (MART) or Neural Networks methods, described in more detail below.

Statistical Analysis Applied to Microarray Data

In the methods described herein, statistical regression analysis is performed using commercially available data mining software packages including, for example, the TreeNet software (Salford Systems, San Diego Calif.), or JMP (SAS Institute Inc., Cary N.C.). These regression analysis tools use gradient-tree boosting, which provides a very general and powerful machine-learning algorithm. The values of a categorical or continuous dependent variable can be predicted from a categorical or continuous predictor variable. This type of analysis uses tree-bending algorithms to determine a set of if-then logical (split) conditions, permitting accurate prediction. Such methods of analysis are useful because they allow rapid classification of new observations, and provide a simpler model for explaining predictions, because of the use of if-then splits, rather than complex or non-linear relationships. Regression tree analysis of this type is particularly well suited to predictive data mining, because no a priori knowledge of the relationships between variables and predictors is required.

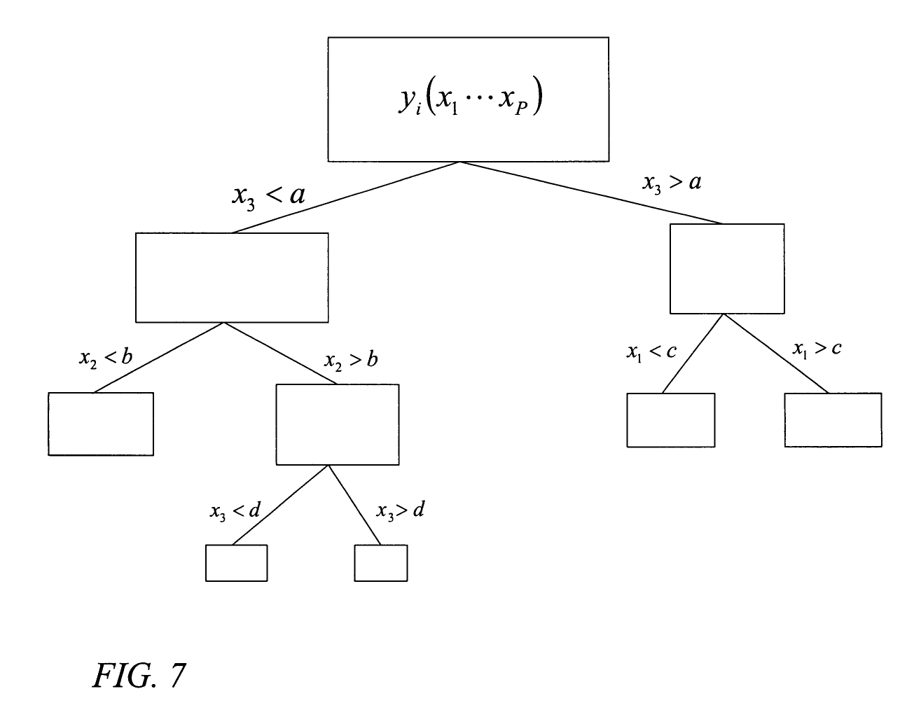

In gradient tree boosting, a sequence of simple trees is computed, with each successive tree being built from the prediction residuals of the preceding tree. A graphical representation of the boosting tree algorithm used with the methods described herein is shown in FIG. 7. For example, if a binary tree is built, then the data is partitioned into two samples at each split. For a single split, three nodes are produced (two child nodes, and a parent node). Applying a boosting tree produces a simple partitioning of the data. The deviation of the observed values from the mean values is determined. A next tree is then fitted to the deviations and another partitioning is done, to further reduce the variance. Such additive weighted expansion (or gradient boosting) of trees produces an excellent fit for predicted values to observed values, even where the relationship between predictors and variables could be very complex. Furthermore, performing consecutive boosting computations on independently drawn samples or observations protects against overfitting of the training data and generates good predictions.

In embodiments of the methods described herein, the categorical dependent variable is the response created from the quality scores assigned to each oligonucleotide probe or a continuous measured variable (i.e. LogRatio). The response variables for each probe can be related to the model predictors, i.e. the probe parameters. Equation II represents the relationship between the probes and the predictive parameters:
yᵢ=yᵢ(x₁, . . . , xₚ) (II)

where i=1, . . . , N; N is the number of probes; P is the number of parameters; and y can be either categorical and take values 1 or 0 or continuous. The regression analysis produces two useful outputs. The model provides relative predictor importance. That is, the statistical model ranks predictors of probe performance, starting with the most important predictor, which is assigned a value of 100%. The most important predictors can then be given a special attention while the least important ones can be completely omitted from the modeling process to accelerate the computational time. The regression analysis also indicates the partial dependence of response variables on particular predictors. That is, the model helps establish the relationship between the response variables and the predictors. This output is usually in the form of a one-dimensional plot suggesting the ranges within which a particular parameter contributes to a particular response. The relationship between the parameters and the response variables is then used to predict performance of oligonucleotide probes for other parts of the genome.

In another embodiment, the Neural Networks model is applied. In this model, the functional dependence of the response is assumed to be in the form shown in Equation III:

$${Y}_{k} = {d}_{k} + \sum {b}_{jk} {H}_{j} \\ with \\ {H}_{j} = S ( {c}_{j} + \sum {a}_{ij} {X}_{i} ) , \\ where \\ S ( x ) = \frac{1}{1 + {ⅇ}^{- x}} \qquad ( III )$$

The advantage with this model is the ability to fit multiple responses at the same time. However, this model is more computationally intensive and has a somewhat lower prediction success than the MART model described above.

In various embodiments, the methods provided herein perform much more robust analysis of data to predict probe performance. In the methods, the importance of each parameter is assessed and weighted accordingly. More rationalized cut-off limits are applied to the parameters used and the data set used to train the model is specifically designed to ensure better results in predicting probe performance. Furthermore, the methods disclosed herein help reduce the resource- and time-consuming empirical validation methods and can be used in place of empirical validation methods, where no model system exists (i.e. where it is not possible to perform an actual experiment).

Arrays

The present description also provides nucleic acid microarrays produced using the subject methods, as described herein. The subject arrays include at least two distinct nucleic acids that differ by monomeric sequence immobilized on, e.g., covalently to, different and known locations on the substrate surface. In certain embodiments, each distinct nucleic acid sequence of the array is typically present as a composition of multiple copies of the polymer on the substrate surface, e.g., as a spot on the surface of the substrate. The number of distinct nucleic acid sequences, and hence spots or similar structures, present on the array may vary, but is generally at least 2, usually at least 5 and more usually at least 10, where the number of different spots on the array may be as a high as 50, 100, 500, 1000, 10,000 or higher, depending on the intended use of the array. The spots of distinct polymers present on the array surface are generally present as a pattern, where the pattern may be in the form of organized rows and columns of spots, e.g., a grid of spots, across the substrate surface, a series of curvilinear rows across the substrate surface, e.g., a series of concentric circles or semi-circles of spots, and the like. The density of spots present on the array surface may vary, but will generally be at least about 10 and usually at least about 100 spots/cm², where the density may be as high as 10⁶ or higher, but will generally not exceed about 10⁵ spots/cm². In other embodiments, the polymeric sequences are not arranged in the form of distinct spots, but may be positioned on the surface such that there is substantially no space separating one polymer sequence/feature from another. An exemplary array is described in U.S. Patent Publication No. 20050095596, which is incorporated herein by reference.

Arrays can be fabricated using drop deposition from pulsejets of either polynucleotide precursor units (such as monomers) in the case of in situ fabrication, or the previously obtained polynucleotide. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. These references are incorporated herein by reference. Other drop deposition methods can be used for fabrication, as previously described herein.

A feature of the subject arrays is that they include one or more, usually a plurality of, oligonucleotide probes predicted by the statistical methods described herein. The oligonucleotide probes selected according to the subject methods are suitable for use in a plurality of different gene expression or genomic microarray applications. The statistical regression method evaluates probe performance, without using any assumptions about the functional relationship between the oligonucleotide sequence and the predictive parameters. Oligonucleotide probes that “cluster” (i.e. consistently produce the same response) will perform substantially similarly under a plurality of different experimental conditions.

The arrays as described herein can be used in a variety of different microarray applications, including gene expression experiments and genomic analysis. In using an array, the array will typically be exposed to a sample (for example, a fluorescently labeled analyte, such as a sample containing genomic DNA) and the array then read. Reading of the array may be accomplished by illuminating the array and reading the location and intensity of resulting fluorescence at each feature of the array to detect any binding complexes on the surface of the array. For example, a scanner may be used for this purpose that is similar to the AGILENT MICROARRAY SCANNER available from Agilent Technologies, Palo Alto, Calif. Other suitable apparatus and methods are described in U.S. patent application Ser. No. 09/846125 “Reading Multi-Featured Arrays” by Dorsel et al.; and Ser. No. 09/430214 “Interrogating Multi-Featured Arrays” by Dorsel et al. As previously mentioned, these references are incorporated herein by reference. However, arrays may be read by any other method or apparatus than the foregoing, with other reading methods including other optical techniques (for example, detecting chemiluminescent or electroluminescent labels) or electrical techniques (where each feature is provided with an electrode to detect hybridization at that feature in a manner disclosed in U.S. Pat. No. 6,221,583 and elsewhere). Results from the reading may be raw results (such as fluorescence intensity readings for each feature in one or more color channels) or may be processed results such as obtained by rejecting a reading for a feature which is below a predetermined threshold and/or forming conclusions based on the pattern read from the array (such as whether or not a particular target sequence may have been present in the sample or an organism from which a sample was obtained exhibits a particular condition). The results of the reading (processed or not) may be forwarded (such as by communication) to a remote location if desired, and received there for further use (such as further processing).

In certain embodiments, the subject methods include a step of transmitting data from at least one of the detecting and deriving steps, as described above, to a remote location. By “remote location” is meant a location other than the location at which the array is present and hybridization occur. For example, a remote location could be another location (e.g. office, lab, etc.) in the same city, another location in a different city, another location in a different state, another location in a different country, etc. As such, when one item is indicated as being “remote” from another, what is meant is that the two items are at least in different buildings, and may be at least one mile, ten miles, or at least one hundred miles apart. “Communicating” information means transmitting the data representing that information as electrical signals over a suitable communication channel (for example, a private or public network). “Forwarding” an item refers to any means of getting that item from one location to the next, whether by physically transporting that item or otherwise (where that is possible) and includes, at least in the case of data, physically transporting a medium carrying the data or communicating the data. The data may be transmitted to the remote location for further evaluation and/or use. Any convenient telecommunications means may be employed for transmitting the data, e.g., facsimile, modem, internet, etc.

Systems

The methods described herein are carried out in part with the aid of a computer-based system, driven by software specific to the methods. A “computer-based system” refers to the hardware, software, and data storage used to analyze the information of the present disclosure. Typical hardware of the computer-based systems of the present disclosure comprises a central processing unit (CPU), input, output, and data storage. A skilled artisan can readily appreciate that any one of the currently available computer-based system are suitable for use in the present disclosure. The data storage means may comprise any manufacture comprising a recording of the present information as described above, or a memory access means that can access such a manufacture. In certain instances a computer-based system may include one or more wireless devices.

To “record” data, programming or other information on a computer-readable medium refers to a process for storing information on a recordable storage medium, using any such methods as known in the art. Examples include magnetic media such as hard drives, tapes, disks, and the like. Optical media can include CDs, DVDs, and the like. Any convenient data storage structure may be chosen, based on the means used to access the stored information. A variety of data processor programs and the formats can be used for storage, e.g., word processing text file, database format, etc.

A “processor” references any hardware and/or software combination that will perform the functions required of it. For example, any processor herein may be a programmable digital microprocessor such as available in the form of an electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

In aspects, the methods described herein are performed using computer-readable media containing programming stored thereon implementing the subject methods. The computer-readable media may be, for example, in the form of a computer disk or CD, a floppy disk, a magnetic “hard card”, a server, or any other computer-readable media capable of containing data or the like, stored electronically, magnetically, optically or by other means. Accordingly, stored programming embodying steps for carrying out the subject methods may be transferred to a computer such as a personal computer (PC), (i.e. accessible by a researcher or the like), by physical transfer of a CD, floppy disk, or like medium, or may be transferred using a computer network, server, or any other interface connection, e.g., the Internet.

In an embodiment, the system described herein may include a single computer or the like with a stored algorithm capable of evaluating probe performance, as described herein, i.e. a computational analysis system that performs statistical regression analysis on a set of training data. In certain embodiments, the system is further characterized in that it provides a user interface, where the user interface presents to a user the option of selecting among one or more different, or multiple different inputs. For example, in the systems described herein, the user has the option of selecting various predictive parameters, such as composition factors, thermodynamic factors, kinetic factors, and mathematical combinations of such factors, as well as analogous parameters for the intended genomic targets.

Computational systems that may be readily modified to become systems of the subject invention include those described in U.S. Pat. No. 6,251,588, the disclosure of which is incorporated herein by reference.

The various embodiments described above are provided by way of illustration only and should not be construed to limit the claims. Those skilled in the art will readily recognize various modifications and changes that may be made to the present methods without following the example embodiments and applications illustrated and described herein, and without departing from the true spirit and scope of the present claims.

1. A method for predicting performance of a probe for use in a microarray application, comprising:
(a) identifying a set of candidate probes for a target nucleic acid of a particular biological model system, wherein the biological model system is one in which a quantitative response is expected with certainty;
(b)hybridizing the set of candidate probe to at least one known sample containing the target nucleic acid to obtain an observed candidate probe performance and comparing the observed candidate probe performance to the expected probe performance for the target nucleic acid for at least one probe parameter to generate a data set for that probe parameter;
(c)) analyzing the data set to establish a relationship between the observed candidate probe performance and the at least one probe parameter to obtain a trained statistical regression model; and
(d) using the trained statistical regression model to predict performance of another set of candidate probes for use with other biological systems.

2. The method of claim 1, wherein identifying a candidate probe further comprises:
(a) generating oligonucleotide probes with sequences complementary to a particular region of a genome, or a particular region of a target nucleic acid sequence.

3. The method of claim 1, wherein comparing the observed candidate probe performance to the expected probe performance for the target nucleic acid for at least one probe parameter comprises:
(a) prior to hybridizing attaching or synthesizing the set of candidate probes on a microarray; and
(b) comparing the hybridization response of the set of candidate probes to the expected response in terms of measured log ratio of signal intensities.

4. The method of claim 3, wherein the measured signal intensities comprise LogRatio, LogIntensity, dye bias, or combinations thereof.

5.-14. (canceled)

15. The method of claim 1, wherein at least analyzing the data set to establish a relationship between the observed candidate probe performance and the at least one probe parameter to obtain a trained statistical regression model is carried out by a computational analysis system.

16. A computer-readable medium having recorded thereon a program that predicts the performance of a probe for use in microarray applications according to the method of claim 1.

17. The computer-readable medium of claim 16, wherein the program that predicts the performance of a probe comprises a computerized statistical algorithm for statistical regression or classification analysis.

18. A computational analysis system comprising the computer-readable medium according to claim 16.

19. A method of fabricating a nucleic acid microarray, comprising producing at least two different oligonucleotide probes on a microarray substrate, wherein at least one of the two different oligonucleotide probes is a probe whose performance is predicted by the method of claim 1.

20. A nucleic acid microarray produced according to the method of claim 18.

21. The method of claim 1, further comprising validating the trained statistical regression model by generating a second set of candidate probes for a second target nucleic acid of a second biological model system, wherein the second biological model system is one for which a quantitative response is expected with certainty, and hybridizing the second set of candidate probes to at least one known sample containing the second target nucleic acid to obtain an observed candidate probe performance of the second set of probes; an analyzing the observed candidate probe performance with the trained statistical regression model to determine if the trained statistical regression model predicts the performance of the second set of candidate probes.

22. The method of claim 1, further comprising validating the trained statistical regression model by dividing the set of candidate probes into a first and second portion, using the first portion of the set of candidate probes to obtain the trained statistical regression model and hybridizing the second portion of candidate probes to at least one known sample containing the target nucleic acid to obtain an observed candidate probe performance of the second portion of probes; and analyzing the observed candidate probe performance with the trained statistical regression model to determine if the trained statistical regression model predicts the performance of the second portion of candidate probes.

23. The method of claim 1, wherein the at least one probe parameter is selected from the group consisting of composition factors, thermodynamic factors, kinetic factors and combinations thereof.

24. The method of claim 23, wherein the composition factor is selected from the group consisting of mole fraction of bases, percentage of GC content, existence of repeat units, existence of restriction sites and combinations thereof.

25. The method of claim 23, wherein the thermodynamic factor is selected from the group consisting of duplex melting temperature, enthalpy of duplex formation, entropy of duplex formation, and combinations thereof.

26. The method of claim 23, wherein the kinetic factor is selected from the group consisting of disassociative rate constants, associative rate constants, enthalpies of activation, entropies of activation, free energy of activation and combinations thereof.

27. The method of claim 1, wherein the candidate set of probes comprises 10 or more probes.
